(19) United States
(12) Patent Application Publication
(10) Pub. No.: US 2024/0299247 A1
(43) Pub. Date: Sep. 12, 2024

(54) CLOSED-TYPE MEDICINE MIXING EXTRACTION DEVICE

(71) Applicant: STS BIO Co., Ltd., Incheon (KR)

(72) Inventors: JUNG GUN PARK, Gyeonggi-do (KR); MAN JIN BANG, Gyeonggi-do (KR); JAE HOON HEO, Gyeonggi-do (KR)

(21) Appl. No.: 18/563,670

(22) PCT Filed: Apr. 19, 2023
(86) PCT No.: PCT/KR2023/005259

§ 371 Date: Nov. 22, 2023

(30) Foreign Application Priority Data
May 26, 2022 (KR) 10-2022-0064566

(51) Int. Cl. A61J 1/20; B01F 21/20; B01F 35/00; B01F 35/71; B01F 101/22

(52) U.S. Cl. CPC A61J 1/2089; B01F 21/22; B01F 35/189; B01F 35/7161; B01F 35/7174; B01F 2101/22

(57) ABSTRACT

A closed-type medicine mixing extraction device for mixing and extracting medicines stored in a first vial and a second vial, respectively, includes a first needle part and a second needle part, which are able to be fitted to the first vial and the second vial, respectively, a connection port to which a syringe is able to be coupled, and a ventilation port through which air is able to enter and exit, wherein the first needle part and the second needle part communicate with each other through a direct communication flow path, the first needle part and the connection port communicate with each other through an extraction flow path, and the second needle part and the ventilation port communicate with each other through a ventilation flow path. Thus, different types of medicines stored in vials, respectively, are able to be hygienically, safely, and rapidly mixed and extracted.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2023/005259, filed Apr. 19, 2023, which claims priority to the benefit of Korean Patent Application No. 10-2022-0064566 filed in the Korean Intellectual Property Office on May 26, 2022, the entire contents of which are incorporated herein by reference.

### BACKGROUND

### 1. Technical Field

The present invention relates to a closed-type medicine mixing extraction device, and more particularly, to a closed-type medicine mixing extraction device capable of hygienically, safely, and rapidly mixing and extracting different types of medicines stored in vials, respectively.

### 2. Background Art

In order to ensure safety of storage and achieve hygienic use, most medicine fluids administered to patients may be manufactured in a powder form or the like and stored in vials, and mixed with a liquid solvent before the administration so as to be reconstructed in a liquid form.

Such a process of mixing different types of medicines to form an injectable liquid medicine fluid may be complex and time-consuming, and there may be various risks of contamination that may occur during the process or infection that nurses and the like performing the process may acquire.

Conventionally, in order to eliminate such risks, a technology of mixing different types of medicines within a syringe through a dual structure in which a syringe having a small diameter is inserted into a syringe having a large diameter has been proposed. However, Since the different types of medicines are stored together inside the syringe, storage safety of the medicines may be inevitably low, and since use of the syringe is inconvenient, and there is a risk of malfunction, a great caution may be required upon the use.

### SUMMARY

The present invention has been proposed to solve the problems of the related art described above, and an object of the present invention is to provide a closed-type medicine mixing extraction device capable of hygienically, safely, and rapidly mixing and extracting different types of medicines stored in vials, respectively.

As a solution of the present invention to achieve the object described above,
there is disclosed a closed-type medicine mixing extraction device for mixing and extracting medicines stored in a first vial and a second vial, respectively, the closed-type medicine mixing extraction device including: a first needle part and a second needle part, which are able to be fitted to the first vial and the second vial, respectively; a connection port to which a syringe is able to be coupled; and a ventilation port through which air is able to enter and exit, wherein the first needle part and the second needle part communicate with each other through a direct communication flow path, the first needle part and the connection port communicate with each other through an extraction flow path, and the second needle part and the ventilation port communicate with each other through a ventilation flow path.

In this case, the first needle part and the second needle part may be formed in opposite directions to each other.

In addition, the connection port and the ventilation port may be formed in opposite directions to each other while being orthogonal to the first needle part and the second needle part.

In addition, the closed-type medicine mixing extraction device may further include a docking connector for coupling the connection port to the syringe, and

The docking connector may include a fixed body installed on the connection port, and a detachable attachment body coupled to the syringe, and the fixed body and the detachable attachment body may be detachably attached to each other while being rotatable relative to each other.

According to a closed-type medicine mixing extraction device of the present invention,
medicine fluids may be mixed within vials, and the mixed medicine fluids may be extracted, so that, above all, the mixing and the extraction of the medicine fluids can be performed hygienically.

In addition, the mixing and the extraction may be performed by manipulating only a syringe while needle parts are fitted to vials in which different types of medicines are stored, respectively, so that medicine fluids can be mixed and extracted very safely, conveniently, and rapidly.

### BRIEF DESCRIPTION OF THE DRAWINGS

FIG. 1 is a view showing one example of a closed-type medicine mixing extraction device according to the present invention.

FIG. 2 is a view showing one example of the closed-type medicine mixing extraction device according to the present invention from s bottom side.

FIG. 3 is a view showing one example of the closed-type medicine mixing extraction device except for an adapter.

FIG. 4 is a view showing one example of FIG. 3 in a cross section.

FIG. 5 is a view showing one example of a docking connector for coupling a connection port to a syringe.

FIG. 6 is a view showing one example of a state in which a first vial, a second vial, and the syringe are coupled to the closed-type medicine mixing extraction device according to the present invention so that preparation for mixing is completed.

FIG. 7 is a view showing one example in which a liquid medicine moves from the first vial to the second vial along a direct communication flow path.

FIG. 8 is a view showing one example of a state in which the closed-type medicine mixing extraction device according to the present invention is rotated so as to be turned upside down after mixing medicines.

FIG. 9 is a view showing one example in which the mixed medicine is extracted from the first vial with the syringe through an extraction flow path.

### DETAILED DESCRIPTION

Hereinafter, a closed-type medicine mixing extraction device according to an exemplary embodiment of the present invention will be described in detail with reference to the accompanying drawings.

A shape of an element, a size of an element, the number of elements, a distance between the elements, and the like in the accompanying drawings may be reduced or exaggerated to emphasize a clearer explanation, and are not limited to the configuration illustrated in the drawings unless specifically limited.

In addition, it should be understood that terms indicating directions such as front, rear, left, right, up, and down are used only to describe a direction shown and observed in the drawings, so that when the direction shown and observed changes, the terms may also be changed.

The present invention relates to a closed-type medicine mixing extraction device capable of hygienically, safely, and rapidly mixing and extracting different types of medicines stored in a first vial and a second vial, respectively.

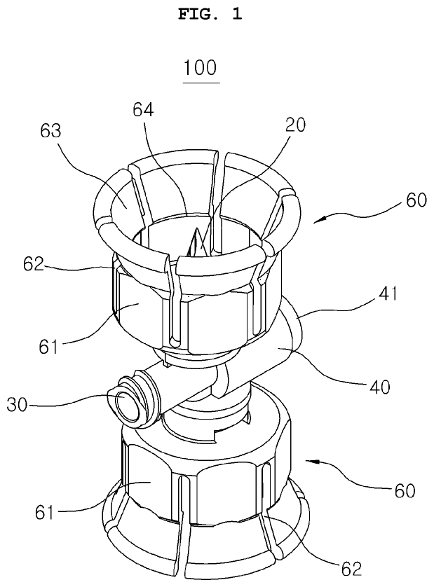

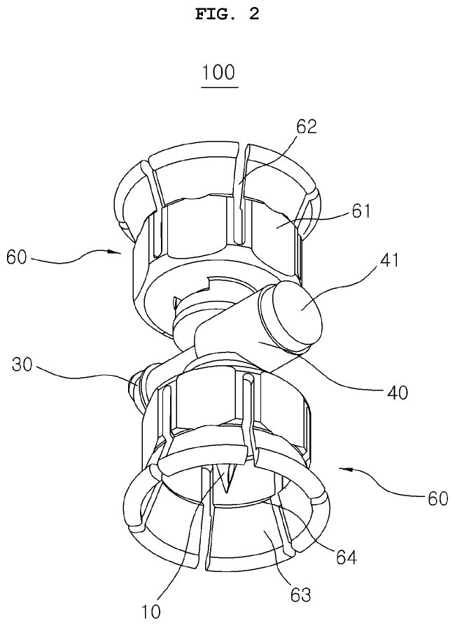

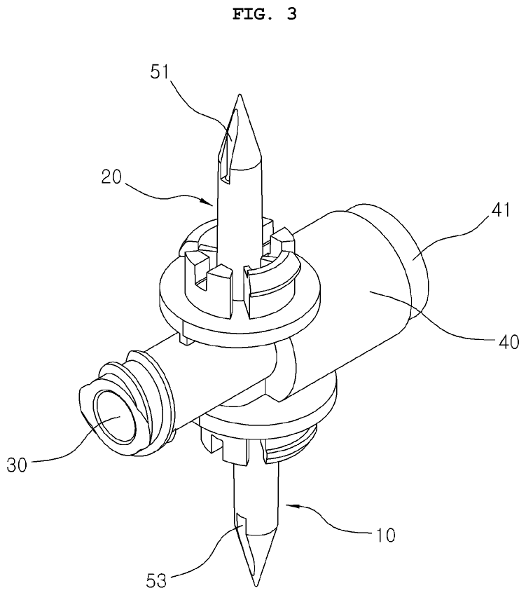

FIGS. 1 to 5 show one example of a closed-type medicine mixing extraction device 100 according to one embodiment of the present invention.

As shown in one example in the drawings, the closed-type medicine mixing extraction device 100 according to one embodiment of the present invention may include a first needle part 10, a second needle part 20, a connection port 30, a ventilation port 40, flow path parts 51, 53, and 55, and an adapter 60.

The first needle part 10 and the second needle part 20 may be parts fitted and coupled to a first vial B1 and a second vial B2, respectively.

In other words, the first needle part 10 may be fitted and coupled to the first vial B1 to communicate with an inside of the first vial B1, and the second needle part 20 may be fitted and coupled to the second vial B2 to communicate with an inside of the second vial B2.

To this end, the first needle part 10 and the second needle part 20 may extend by predetermined lengths, respectively, and may have outer diameters that are gradually decreased in a longitudinal direction to have sharp ends so as to be easily fitted to the vials B1 and B2, respectively.

The first needle part 10 and the second needle part 20 may be formed in opposite directions to each other, that is, at an angle of 180 degrees to each other.

Therefore, when the sharp end of the first needle part 10 is directed upward, the sharp end of the second needle part 20 may be directed downward, and conversely, when the sharp end of the second needle part 20 is directed upward, the sharp end of the first needle part 10 may be directed downward.

In addition, the first needle part 10 and the second needle part 20 may be offset from each other by a predetermined distance d without being located at the same position in a vertical direction so that the flow path parts 51, 53, and 55 for allowing the first needle part 10 and the second needle part 20 to communicate with each other and communicate with the connection port 30 or the ventilation port 40 may be easily formed along insides of the first needle part 10 and the second needle part 20 as will be described below.

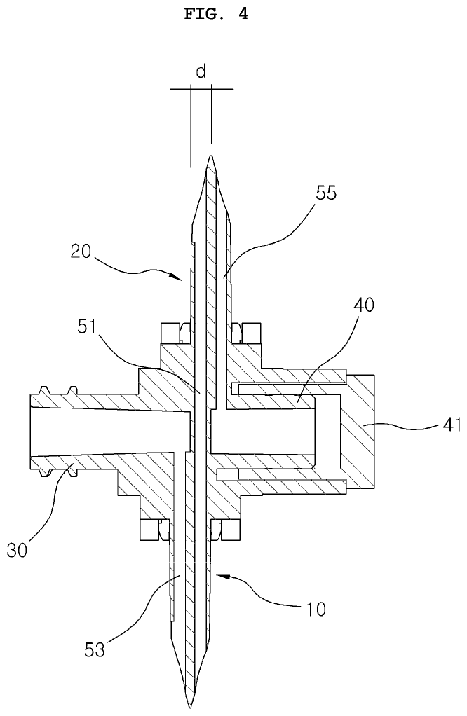

In other words, as shown in one example of FIG. 4, the sharp end of the first needle part 10 and the sharp end of the second needle part 20 may be spaced apart from each other by the predetermined distance d, and a direct communication flow path 51, which will be described below, may be formed in a straight line within the separation distance.

The connection port 30 may be a part in which a syringe 300 for extracting a medicine is coupled.

In other words, the syringe 300 may be coupled to the connection port 30 so as to be connected to the closed-type medicine mixing extraction device 100 according to the present invention.

The ventilation port 40 may be a part in which air enters and exits to allow flow communication.

A filter member 41 capable of filtering out contaminants in the air may be installed in the ventilation port 40.

For example, the filter member 41 may be inserted into the ventilation port 40 and firmly fixed through ultrasonic fusion.

The connection port 30 and the ventilation port 40 may be formed in opposite directions to each other while being orthogonal to the first needle part 10 and the second needle part 20.

For example, as shown in one example in the drawings, when the first needle part 10 and the second needle part 20 are located vertically, the connection port 30 and the ventilation port 40 may be located horizontally so as to be orthogonal to the first needle part 10 and the second needle part 20. In this case, the connection port 30 and the ventilation port 40 may form an angle of 180 degrees between each other so as to be formed in forward-rearward or left-right opposite directions.

In other words, when an entire configuration of the first needle part 10, the second needle part 20, the connection port 30, and the ventilation port 40 is observed, an approximate ‘+’ shape may be formed.

The flow path parts 51, 53, and 55 may be parts for providing a medicine movement path and an air movement path for the mixing and the extraction of the medicine.

To this end, the flow path parts 51, 53, and 55 may include a direct communication flow path 51, an extraction flow path 53, and a ventilation flow path 55, which provide flow paths independent of each other, respectively.

The direct communication flow path 51 may be a flow path for allowing the first needle part 10 and the second needle part 20 to communicate with each other, and may be formed along the insides of the first needle part 10 and the second needle part 20 to extend from the first needle part 10 to the second needle part 20.

In other words, the first needle part 10 and the second needle part 20 may communicate with each other through the direct communication flow path 51, so that when the first needle part 10 is fitted to the first vial B1, and the second needle part 20 is fitted to the second vial B2, the first vial B1 and the second vial B2 may also communicate with each other through the direct communication flow path 51, and as a result, a medicine stored in each vial may move to another vial through the direct communication flow path 51.

As described above, the direct communication flow path 51 may be formed in a straight line along the separation distance d between the first needle part 10 and the second needle part 20, which are offset from each other.

The extraction flow path 53 may be a flow path for allowing the first needle part 10 and the connection port 30 to communicate with each other, and may extend from the first needle part 10 to the connection port 30.

In other words, the first needle part 10 and the connection port 30 may communicate with each other through the extraction flow path 53.

The ventilation flow path 55 may be a flow path for allowing the second needle part 20 and the ventilation port 40 to communicate with each other, and may extend from the second needle part 20 to the ventilation port 40.

In other words, the second needle part 20 and the ventilation port 40 may communicate with each other through the ventilation flow path 55.

The adapter 60 may be a part provided on each of the first needle part 10 and the second needle part 20 so as to be coupled to a head part of each of the vials B1 and B2 to fix the first needle part 10 and the second needle part 20 to the vials B1 and B2, respectively, when the first needle part 10 and the second needle part 20 are fitted to the first vial B1 and the second vial B2, respectively.

The adapter 60 may be configured such that a plurality of incision slits 62 are formed at regular intervals on an adapter body 61 having a cylindrical shape, an inclined surface 63 is formed on an inner lower side of the adapter body 61, and a latching sill 64 is formed at an upper end of the inclined surface 63.

The adapter 60 may be configured such that when the first needle part 10 or the second needle part 20 is fitted to the first vial B1 or the second vial B2, the adapter body 61 is elastically opened by the inclined surface 63 and the incision slits 62 so as to be fitted around the head part of each of the vials B1 and B2, and elastically restored to allow the latching sill 64 to be latched and supported to a lower end of the head part of the vial, thereby fixing the first needle part 10 or the second needle part 20 to each of the vials B1 and B2.

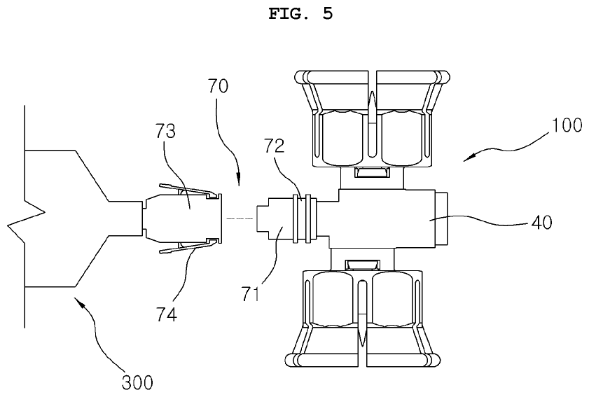

Meanwhile, in some embodiments, the closed-type medicine mixing extraction device 100 according to the present invention as described above may further include a docking connector 70 as shown in one example of FIG. 5.

The docking connector 70 may be a part for allowing the syringe 300 to be easily coupled to or separated from the connection port 30, and may include a fixed body 71 and a detachable attachment body 73, which are detachably attached to each other.

The fixed body 71 may be fixedly installed on the connection port 30, and may be formed on an outer peripheral surface thereof with a latching groove part 72.

The detachable attachment body 73 may be coupled to the syringe 300, and may be formed on an outer peripheral surface thereof with a pair of hook arms 74 in which a gap between the hook arms 74 is elastically widened or restored.

The docking connector 70 may be configured such that while the fixed body 71 is fixed to the connection port 30, and the detachable attachment body 73 is coupled to the syringe 300, the detachable attachment body 73 is fitted to the fixed body 71, so that the pair of hook arms 74 may be elastically latched to the latching groove part 72 to couple the fixed body 71 and the detachable attachment body 73 to each other, and the pair of hook arms 74 may be pressed to release the latching from the latching groove part 72 to separate the fixed body 71 and the detachable attachment body 73 from each other.

In addition, in the coupled state, the pair of hook arms 74 may move in a circumferential direction along the latching groove part 72, so that the fixed body 71 and the detachable attachment body 73 may rotate relative to each other.

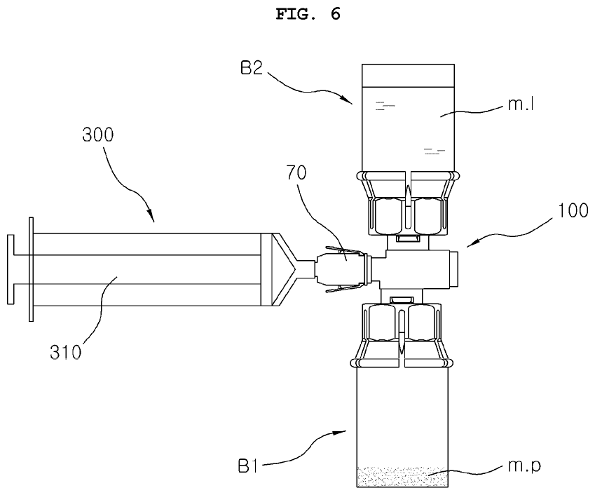

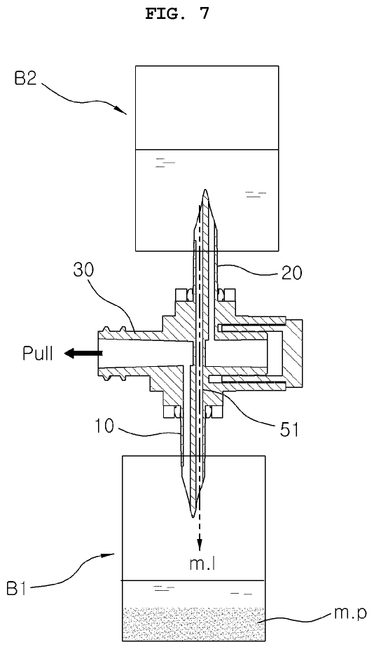

The closed-type medicine mixing extraction device 100 according to one embodiment of the present invention has been described above. Hereinafter, an operation of mixing and extracting medicines will be discussed with reference to FIGS. 6 to 9.

According to the present invention, medicines stored in the first vial B1 and the second vial B2, respectively, may be mixed with each other. In this case, the medicines stored in the first B2, respectively, are not vial B1 and the second vial particularly limited, and may be, for example, different types of liquid medicines, or may be a medicine in a powder form and a liquid exclusive solvent for dissolving the medicine.

However, since the present invention is more effective in extracting an injectable medicine fluid by mixing a powder medicine in a powder form with a liquid medicine that is an exclusive solvent, hereinafter, one example in which a powder medicine m.p is stored in the first vial B1, and an exclusive liquid medicine m.l for dissolving the powder medicine m.p is stored in the second vial B2 will be described.

When the first vial B1 for storing the powder medicine m.p and the second vial B2 for storing the liquid medicine m.l are prepared, first, the first needle part 10 may be fitted to the first vial B1, and the second needle part 20 may be fitted to the second vial B2.

In this case, the first needle part 10 and the second needle part 20 may be fixed to the first vial B1 and the second vial B2 with predetermined fixing strength while being fitted to the first vial B1 and the second vial B2 as the adapter 60 is coupled to each of the first vial B1 and the second vial B2.

In addition, the syringe 300 may be coupled to the connection port 30 by using the docking connector 70.

In other words, the detachable attachment body 73 coupled to the syringe 300 may be fitted to the fixed body 71 installed on the connection port 30 to allow the pair of hook arms 74 to be latched to the latching groove part 72 so that the syringe 300 may be coupled to the connection port 300.

Naturally, since the above order is merely one example, the order may be changed to proceed in an order of first coupling and connecting the syringe 300 to the connection port 30, and fitting the first needle part 10 and the second needle part 20 to the first vial B1 and the second vial B2.

As described above, when the first needle part 10 and the second needle part 20 are fitted and coupled to the first vial and the second vial, respectively, and the syringe 300 is coupled and connected to the connection port 30, preparation for the mixing and the extraction may be completed, and FIG. 6 shows one example of the present invention in which the preparation is completed.

When the preparation is completed as described above, while the first needle part 10 is located to face downward, and the second needle part 20 is located to face upward, that is, while the first vial B1 for storing the powder medicine m.p is located upright on a lower side, and the second vial B2 for storing the liquid medicine m.l is located on an upper side while being inverted as illustrated in FIG. 6, a push rod 310 of the syringe 300 may be pulled to move rearward (Pull).

Then, as the air inside the first vial B1 escapes into the syringe 300 through the extraction flow path 53, a negative pressure may be formed inside the first vial B1, and the liquid medicine m.l stored in the second vial B2 may be sucked and moved into the first vial B1 through the direct communication flow path 51 due to a difference in pressures inside the first vial B1 and the second vial B2 caused by the negative pressure.

In other words, the liquid medicine m.l in the second vial B2 may be rapidly moved along the direct communication flow path 51 from the second vial B2 so as to be introduced into the first vial B1 by a suction force generated according to the difference in the pressures inside the first vial B1 and the second vial B2.

When the liquid medicine m.l in the second vial B2 is introduced into the first vial B1 as described above, shaking may be performed to allow the powder medicine m.p and the liquid medicine m.l to be well mixed within the first vial B1, so that the powder medicine m.p and the liquid medicine m.l may be mixed inside the first vial B1 so as to be reconstructed into an injectable mixed medicine fluid M.

When the mixing of the powder medicine m.p and the liquid medicine m.l is completed as described above, subsequently, the push rod 310 of the syringe 300 may be pushed to move forward.

Then, the air inside the syringe 300 may be supplied back to the first vial B1 so that a pressure balance between the first vial B1 and the second vial B2 may be achieved.

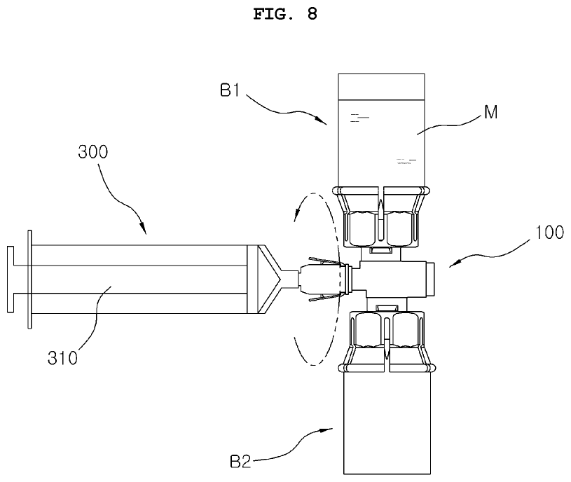

Subsequently, in order to extract the mixed medicine M stored inside the first vial B1, as shown in one example of FIG. 8, the closed-type medicine mixing extraction device 100 according to the present invention may be rotated 180 degrees so as to be turned upside down.

In other words, while the syringe 300 is gripped, the closed-type medicine mixing extraction device 100 may be rotated 180 degrees so that the first vial B1 may be located on the upper side, and the second vial B2 may be located on the lower side.

In this case, since the docking connector 70 that connects the syringe 300 to the mixing extraction device 100 according to the present invention includes the fixed body 71 and the detachable attachment body 73, which may be rotated relative to each other, the mixing extraction device 100 may be conveniently rotated while the syringe 300 is gripped.

When rotated as described above, an inverted state in which the first vial B is located on the upper side may be achieved as shown in one example of FIG. 8, and in this case, the push rod 310 of the syringe 300 may be pulled to move rearward.

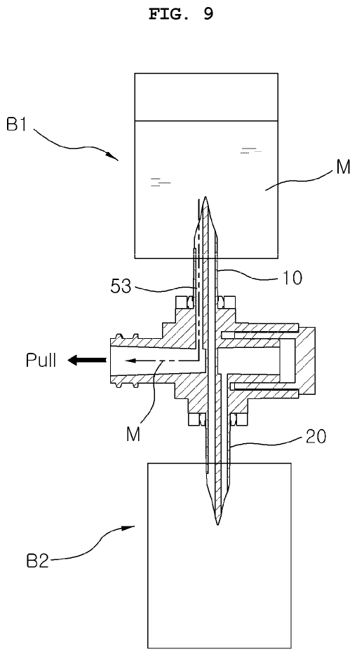

Then, as shown in one example of FIG. 9, a negative pressure may be formed inside the syringe 300, and the mixed medicine fluid M stored in the first vial B1 may escape into the syringe 300 through the extraction flow path 53 due to a pressure difference caused by the negative pressure so as to be extracted.

As described above, according to the present invention, safety may be ensured without any concerns about introduction of external foreign substances, a leakage of medicines, or the like, and in particular, when the needle parts are fitted to the vials, respectively, and the syringe is simply manipulated, the medicines may be rapidly mixed within the vial, so that it is very easy and convenient to use, and the medicines fluids may be mixed and extracted hygienically without concerns about contamination, infection, or the like.

1: A closed-type medicine mixing extraction device configured for mixing and extracting medicines stored in a first vial and a second vial, respectively, the closed-type medicine mixing extraction device comprising:
a first needle part and a second needle part, which are able to be fitted to the first vial and the second vial, respectively;
a connection port to which a syringe is able to be coupled; and
a ventilation port through which air is able to enter and exit,
wherein the first needle part and the second needle part are configured to communicate with each other through a direct communication flow path,
the first needle part and the connection port are configured to communicate with each other through an extraction flow path, and
the second needle part and the ventilation port are configured to communicate with each other through a ventilation flow path.

2: The closed-type medicine mixing extraction device of claim 1, wherein the first needle part and the second needle part are formed in opposite directions to each other.

3: The closed-type medicine mixing extraction device of claim 2, wherein the connection port and the ventilation port are formed in opposite directions to each other while being orthogonal to the first needle part and the second needle part.

4: The closed-type medicine mixing extraction device of claim 1, further comprising a docking connector configured for coupling the connection port to the syringe,
wherein the docking connector includes a fixed body installed on the connection port, and a detachable attachment body coupled to the syringe, and
the fixed body and the detachable attachment body are able to be detachably attached to each other while being rotatable relative to each other.
